(19) United States
(12) Patent Application Publication
(10) Pub. No.: US 2009/0128961 A1
(43) Pub. Date: May 21, 2009

(54) DISK APPARATUS

(75) Inventor: Yoshihiro Arikawa, Kawasaki (JP)

Correspondence Address: GREER, BURNS & CRAIN, 300 S WACKER DR, 25TH FLOOR, CHICAGO, IL, 60606, US

(73) Assignee: FUJITSU LIMITED, Kawasaki-shi (JP)

(21) Appl. No.: 12/196,944

(22) Filed: Aug. 22, 2008

(30) Foreign Application Priority Data
Nov. 15, 2007 (JP) 2007-297071

(51) Int. Cl. G11B 5/54

(52) U.S. Cl. 360/256.2; G9B/21.027

(57) ABSTRACT

In a disk apparatus, an actuator includes a magnetic plate member which generates a magnetic attraction force for turning the actuator in the unloading direction by interaction with a stationary magnet. The plate member is superposed on the stationary magnet in the plane direction while keeping a gap with the stationary magnet in the vertical direction. An area of the plate member superposed on the stationary magnet is increased as the actuator turns in the unloading direction and approaches the outer stopper. When the actuator approaches the outer stopper, the stationary magnet gives, to the plate member, a magnetic attraction force of such an intensity that brings the actuator on the outer stopper against a friction force applied to the actuator.

### BACKGROUND OF THE INVENTION

1. Field of the Invention

The present invention relates to a disk apparatus such as a magnetic disk apparatus which accesses a disk by a head provided on a tip end of an actuator.

2. Description of the Related Art

In a magnetic disk apparatus, low-floating tendency of a head is rapidly going further with the recent increase in capacity. Thus, a medium including a magnetic disk is more flattened, a contact start stop (CSS) system in which a head comes into contact with the medium when the disk apparatus is not operated has a limitation, and a ramp load system in which a head is evacuated to a ramp disposed on an outer periphery has become mainstream. In the case of a ramp load system, if the head is loaded on a medium when the disk apparatus is not operated, the head and the medium may adsorb to each other occur since both the head and the medium are flat, and there is an adverse possibility that the disk apparatus cannot be operated. Thus, the disk apparatus often includes a latch mechanism so that the head does not slip off from the ramp and fall on the medium even when an impact or vibration is added to the apparatus when it is not operated. The latch mechanism mainly includes two elements, i.e., a magnetic attraction force which pulls back an actuator from a certain position on the ramp to an outer stopper which should be in a state where the actuator abuts against the outer stopper, and an inertia latch mechanism which prevents the actuator from jumping out when an impact is added.

Here, as methods for generating a magnetic attraction force which pulls back the actuator to the outer stopper, there are:

(a) a method for pulling back the actuator by applying leakage magnetic flux of a magnetic circuit to a metal material mounted on a rear end of the actuator on a side of a coil; and

(b) a method in which a magnet is embedded in a stopper, and the actuator is pulled back by the magnet.

In the case of the method (a), it is possible to generate a magnetic attraction force even in a case in which the head is on a location of the ramp closer to the medium. However, when the head is located at an outer stopper position on the ramp which is farthest from the medium, the magnetic attraction force becomes small, and there is a possibility that the generated magnetic attraction force is not sufficient to completely push the actuator against the outer stopper due to assembling variation, variation between parts or the like. In this case, if vibration is applied to the apparatus, the actuator is finely vibrated by an amount of gap between the actuator and the outer stopper, and due to this fine vibration, the ramp and a load tub which is molded on a tip end of a suspension supporting the head and which slides on the ramp rub against each other to generate dust, the dust may be a cause to further lead to a problem that the reading operation of the head is hindered due to the dust.

According to the method (b), although the magnetic attraction force at the position of the outer stopper can be increased, there is a drawback that the application range of the magnetic attraction force is narrow, and if the actuator moves slightly away from the outer stopper, the actuator cannot be pulled back to the outer stopper. In this case, when an impact by which the actuator is moved and thus should be caught by the inertia latch is applied to the apparatus, the actuator may be left at a position to which the actuator moved even after the impact subsides, and when a further impact is applied thereafter, there is a possibility that the actuator and the inertia latch are not timed and the head is loaded on the medium.

As described above, according to the conventional technique, both the methods (a) and (b) should be employed to apply the magnetic attraction force in a wide range and to secure the magnetic attraction force for pushing the actuator against the outer stopper at the position of the outer stopper, and this increases the cost.

### SUMMARY OF THE INVENTION

The present invention has been made in view of the above circumstances and provides a disk apparatus which generates a magnetic attraction force capable of reliably pushing the actuator against the outer stopper while suppressing the increase in cost and while keeping a wide range of application of the magnetic attraction force.

A disk apparatus according to the invention include:

a disk on which information is stored,

a stationary magnet,

an actuator which is turnably supported, which is provided at its tip end with a head that accesses the disk, which is provided at its rear end with a coil that generates a driving force by interaction between the stationary magnet and the actuator, and which is turned by the driving force,

a ramp which holds a tip end of the actuator at an unloading position that is away from the disk, and

an outer stopper which abuts against the rear end of the actuator and which determines the maximum turning position of the actuator in an unloading direction, wherein

the actuator includes a magnetic plate member fixed to the rear end of the actuator and to a tip end of the actuator in the unloading direction, the plate member generates a magnetic attraction force which turns the actuator in the unloading direction by interaction between the stationary magnet and the plate member, the plate member is superposed with the stationary magnet in a plane direction while keeping a gap with the stationary magnet in an up-and-down direction, and an area of the plate member superposed on the stationary magnet is increased as the actuator turns in the unloading direction and approaches the outer stopper, and

when the actuator is in a position close to the outer stopper, the stationary magnet gives, to the plate member, a magnetic attraction force having such an intensity as to cause the actuator to abut on the outer stopper against a friction force applied to the actuator.

According to the disk apparatus of the present invention, when the stationary magnet is in a position where the actuator is near to the outer stopper, the stationary magnet applies, to the plate member, a magnetic attraction force of such an intensity that causes the actuator to abut on the outer stopper against a friction force applied to the actuator. Therefore, the actuator stably stays at a position where the actuator abuts against the outer stopper, fine vibration of a tip end of the actuator is suppressed even during transportation, and dust is prevented from generating. To obtain this, it is unnecessary to embed a magnet in the outer stopper in addition to the stationary magnet, and the cost can be reduced.

In the disk apparatus of the present invention, it is preferable that the stationary magnet gives a magnetic attraction force in the unloading direction to the plate member to a position where the actuator further turns 2° or more in the unloading direction than an outer stopper position where the actuator abuts against the outer stopper when the outer stopper does not exist.

If the stationary magnet applies a magnetic attraction force in the unloading direction to the plate member up to the position in which the actuator is further turned 20 or more in the unloading direction, the actuator can stably abut against the outer stopper in any disk apparatuses even if manufacturing variation of a large number of disk apparatuses is taken into account.

In the disk apparatus of the present invention, it is preferable that the disk apparatus further includes an inertia latch which receives a driving force by an impact simultaneously when the actuator located in the unloading position receives a driving force in the loading direction by the impact and engages the actuator while the tip end of the actuator is on the ramp, thereby preventing the tip end of the actuator from disengaging from the ramp, wherein the stationary magnet gives a magnetic attraction force in the unloading direction to the plate member to a position turned in a direction farther away from the outer stopper than a position where the actuator is engaged with the inertia latch.

If the stationary magnet applies a magnetic attraction force in the unloading direction to the plate member up to a position which is further turned in a direction away from the outer stopper than a position where the actuator is engaged by the inertial latch, accidental loading of the head on the disk can be prevented.

In addition, in the disk apparatus of the present invention, it is preferable that when the actuator is in a position where the actuator is engaged with the inertia latch, the stationary magnet gives, to the plate member, a magnetic attraction force having an intensity that pulls the actuator back to an outer stopper position where the actuator abuts against the outer stopper from the former position.

The disk apparatus has a magnetic attraction force of this level, accordingly, the actuator can be stably placed at the position where the actuator abuts against the outer stopper, and the accidental loading of the head on the disk can further reliably be prevented.

Further, in the disk apparatus of the present invention, it is preferable that when the actuator is away from the outer stopper and the head mounted on the tip end of the actuator moves toward the loading position where the head is superposed on the disk, the plate member moves to a position which is out of a region where an influence of a magnetic attraction force from the stationary magnet acts before the actuator reaches the loading position.

The influence of the magnetic attraction force in loading position is eliminated, to control to cause the head to seek a desired position and to be on-tracked a desired position at becomes easy.

According to the present invention, it is possible to inexpensively obtain a mechanism which reliably pushes the actuator against the outer stopper.

### BRIEF DESCRIPTION OF THE DRAWINGS

FIG. 1 is a plan view of a magnetic disk apparatus which is one embodiment of a disk apparatus of the present invention;

FIG. 2 is a diagram showing a magnetic attraction force received by a plate from a stationary magnet in a conventional magnetic disk apparatus (comparative example 1, hereinafter);

FIG. 3 is a diagram showing a positional relationship of an actuator with respect to a ramp and an outer stopper;

FIG. 4 is a diagram showing shapes of the stationary magnet and the plate, and a position of the plate in each turning position of the actuator in the comparative example 1;

FIG. 5 is a diagram showing a magnetic attraction force received from a magnet in a magnetic disk apparatus (comparative example 2, hereinafter) of a type in which the magnet is embedded in an outer stopper in the conventional technique;

FIG. 6 is a diagram showing a positional relationship of an actuator with respect to a ramp and an outer stopper in the comparative example 2;

FIG. 7 is a diagram showing shapes of the stationary magnet and the plate, and a position of the plate in each turning position of the actuator in the comparative example 2;

FIG. 8 is a diagram showing a magnetic attraction force received by the plate from a stationary magnet in a magnetic disk apparatus (embodiment, hereinafter) shown in FIG. 1;

FIG. 9 is a diagram showing a positional relationship of an actuator with respect to a ramp and an outer stopper in the embodiment;

FIG. 10 is a diagram showing shapes of the stationary magnet and the plate, and a position of the plate in each turning position of the actuator in the conventional example; and

FIG. 11 is a diagram in which a shape of the stationary magnet of the embodiment is superposed on the stationary magnet of the comparative example 1 and on the stationary magnet of the comparative example 2.

### DETAILED DESCRIPTION OF THE INVENTION

An embodiment of the present invention will be explained below.

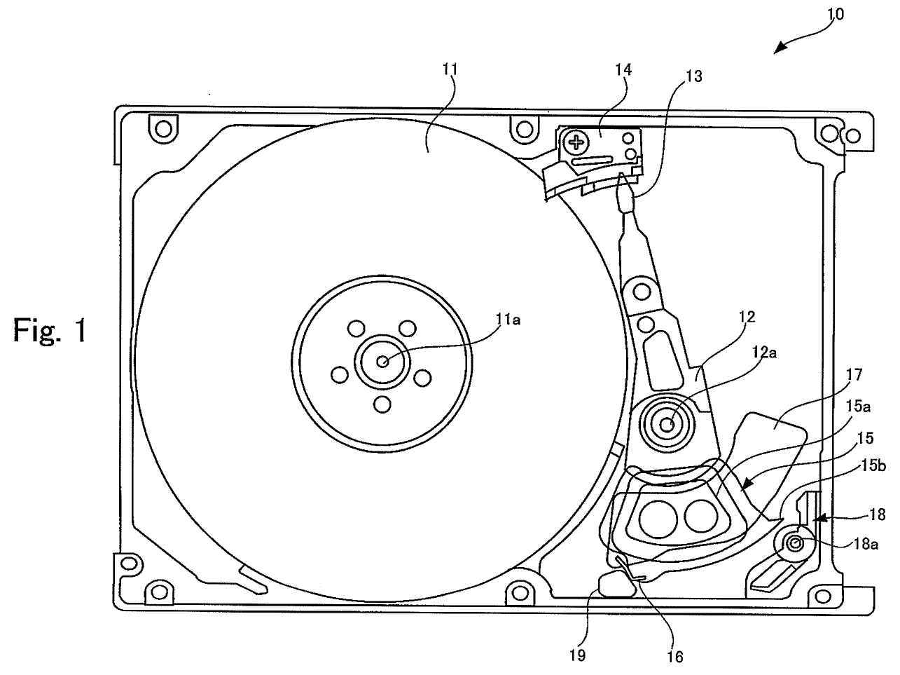

FIG. 1 is a plan view of a magnetic disk apparatus which is one embodiment of a disk apparatus of the present invention.

A magnetic disk apparatus shown in FIG. 1 includes a magnetic disk 11 which is rotated by a spindle motor (not shown) around a rotation shaft 12a, an actuator 12 which turns around the rotation shaft 12a, a magnetic head 13 which is mounted on a tip end of the actuator 12, and which is opposed to the magnetic disk and accesses the magnetic disk 11 by turning motion of the actuator 12, and a ramp 14 on which the tip end of the actuator 12 is placed when the magnetic head 13 mounted on the actuator 12 is in an unloading position away from the magnetic disk 11. The magnetic disk apparatus 10 further includes a coil 15a and a magnetic plate 16 provided on a rear end 15 of the actuator 12. A stationary magnet 17 is provided at a position in a vertical direction with respect to the rear end 15 of the actuator 12. If current flows through the coil 15a, the actuator 12 turns between an unloading position shown in FIG. 1 and a loading position where the magnetic head 13 moves above the magnetic disk 11 by the interaction between the current of the coil 15a and the magnetic force of the stationary magnet 17.

In addition, the magnetic plate 16 receives a magnetic attraction force in the unloading direction from the stationary magnet 17, and generates a driving force to turn the actuator 12 in the unloading direction. Details thereof will be described later.

Further, the magnetic disk apparatus 10 is provided with an outer stopper 19. The outer stopper 19 is an element to determines a turning limit of the actuator 12 in the unloading direction such that the rear end 15 of the actuator 12 which turns in the unloading direction abuts the outer stopper 19. Here, the turning position of the actuator in a state where the rear end 15 of the actuator 12 is in abutment against the outer stopper 19 is called an outer stopper position.

Furthermore, the magnetic disk apparatus 10 is provided with an inertia latch 18. When an impact is applied to the magnetic disk apparatus 10 and a force in the loading direction acts on the actuator 12, the inertia latch 18 turns around a shaft 18a by the same impact and is engaged with a tip end 15b in the loading direction of the rear end 15 of the actuator 12, thereby preventing the actuator 12 from further turning in the loading direction, and this prevents the magnetic head 13 from accidentally loading on the magnetic disk 11.

Next, a magnetic attraction force from the stationary magnet 17 received by the magnetic plate 16 provided on the rear end 15 of the actuator 12 will be explained.

Comparative examples will be explained first for the sake of explanation.

### COMPARATIVE EXAMPLE 1

A comparative example 1 shown here corresponds to the conventional technique (a) described above.

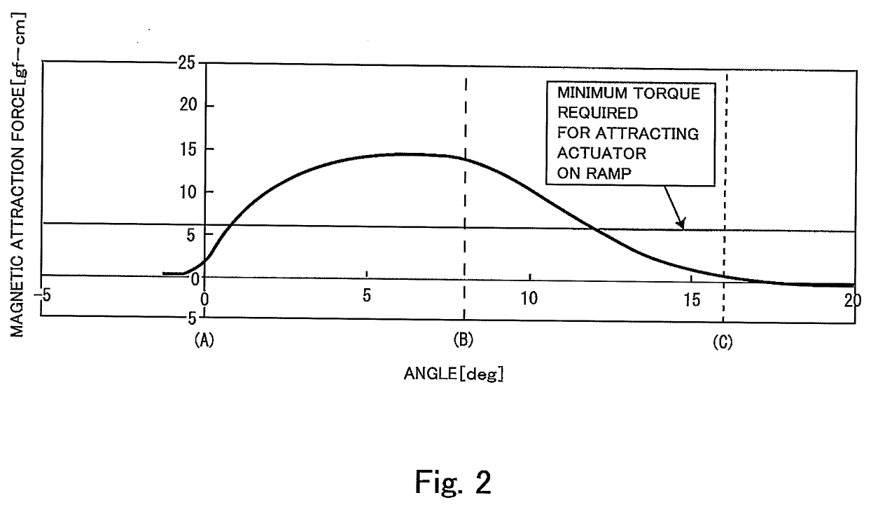

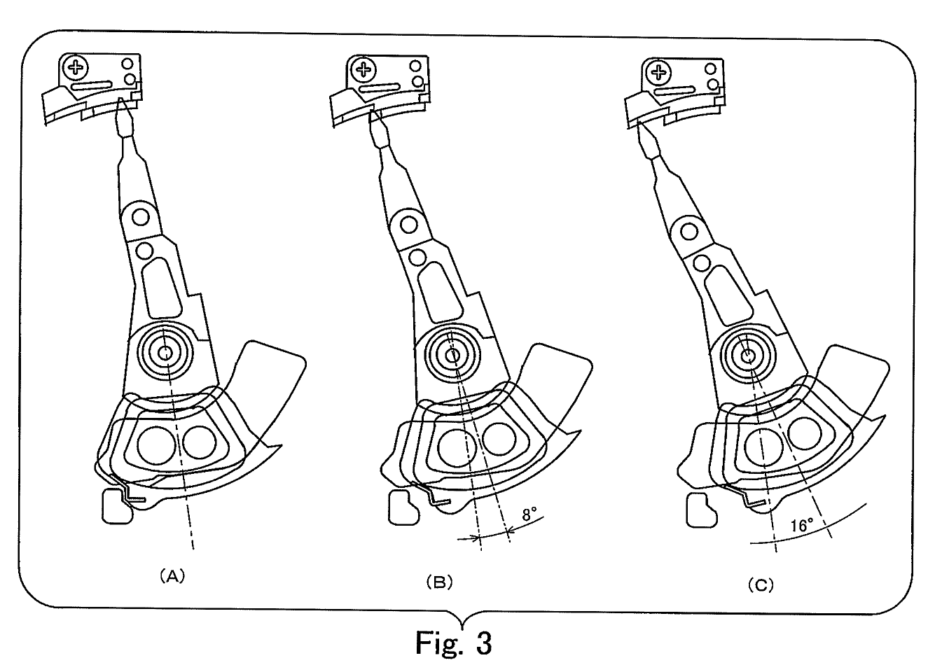

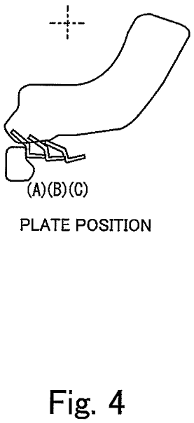

FIG. 2 is a diagram showing a magnetic attraction force received by a plate from a stationary magnet in a conventional magnetic disk apparatus (comparative example 1, hereinafter) FIG. 3 is a diagram showing a positional relationship of an actuator with respect to a ramp and an outer stopper. FIG. 4 is a diagram showing shapes of the stationary magnet and the plate, and a position of the plate in each turning position of the actuator in the comparative example 1. In FIG. 4, a mark (+) represents a turning center of the actuator.

Here, (A), (B) and (C) in FIGS. 2 to 4 respectively correspond to one another: (A) shows an outer stopper position where the actuator abuts against the outer stopper, (B) shows an inertia latch catch position where the inertia latch engages the actuator, and (C) shows a head loading position where the magnetic head starts loading onto the magnetic disk.

In the case of the comparative example 1, a force for pulling the actuator back to the outer stopper position (A) is applied to the actuator in a wide angle range, and this point is preferable. However, a magnetic attraction force in the outer stopper position (A) is weak, the probability that the actuator is finely vibrated due to vibration during transportation is high, the ramp and the tip end of the actuator come into slide contact to generate dust, and the probability of access failure of the magnetic disk by the magnetic head becomes high.

Further, in the head loading position (C), a magnetic attraction force slightly reamins, and control of seek and on-track by flowing current through the coil is adversely affected.

### COMPARATIVE EXAMPLE 2

A comparative example 2 shown here corresponds to the conventional technique (b).

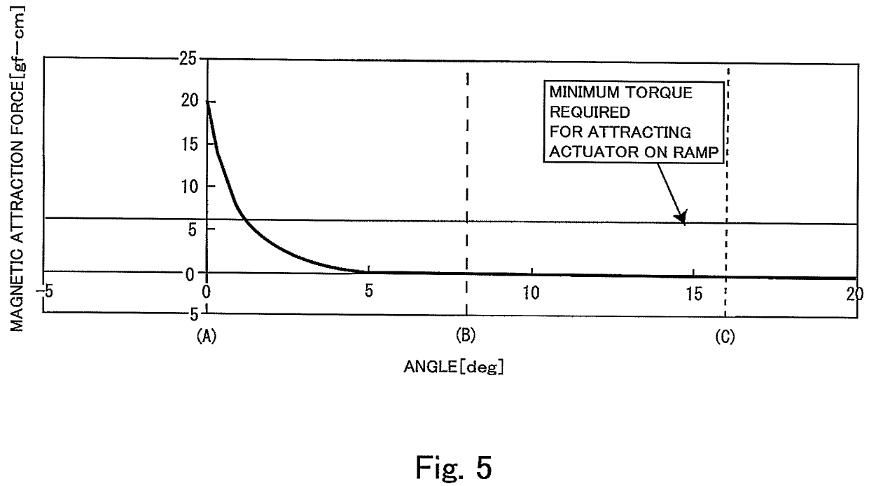

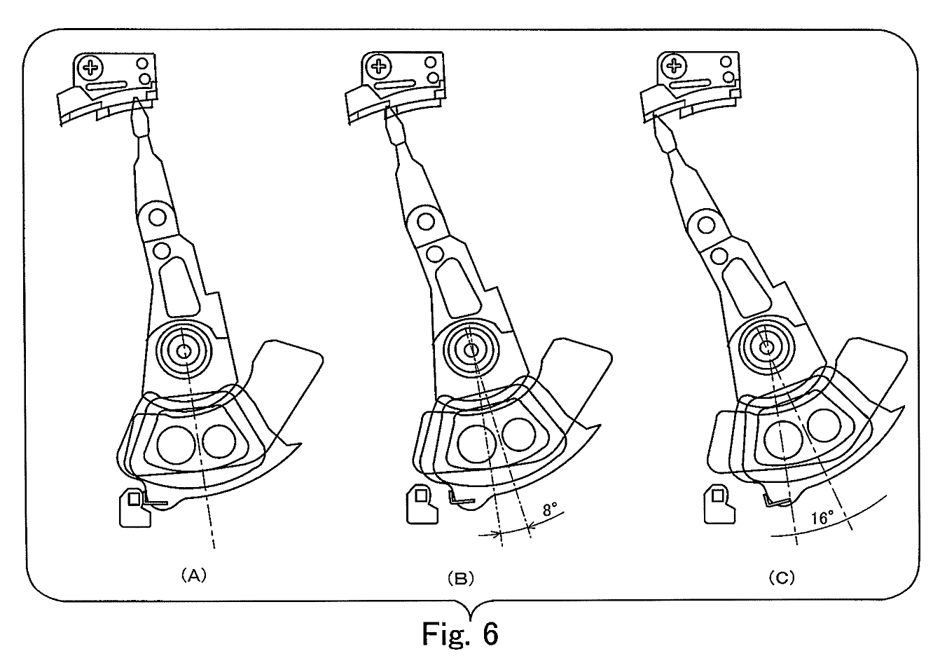

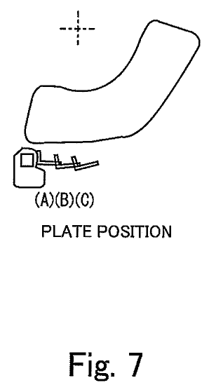

FIG. 5 is a diagram showing a magnetic attraction force received from a magnet in a magnetic disk apparatus (comparative example 2, hereinafter) of a type in which the magnet is embedded in an outer stopper in the conventional technique. FIG. 6 is a diagram showing a positional relationship of an actuator with respect to a ramp and an outer stopper in the comparative example 2. FIG. 7 is a diagram showing shapes of the stationary magnet and the plate, and a position of the plate in each turning position of the actuator in the comparative example 2. In FIG. 7, a mark (+) represents a turning center of the actuator similarly to FIG. 4.

Here, (A), (B) and (C) in FIGS. 5 to 7 respectively correspond to one another. Similarly to the comparative example 1, (A) shows an outer stopper position where the actuator abuts against the outer stopper, (B) shows an inertia latch catch position where the inertia latch engages the actuator, and (C) shows a head loading position where the magnetic head starts loading onto the magnetic disk.

In the case of the comparative example 2, although a sufficient magnetic attraction force exists in the outer stopper position (A), the application range of the magnetic attraction force is narrow. For example, if the inertia latch acts due to an impact and the actuator turns to the inertia latch catch position, the actuator cannot return to the outer stopper position by its own force, and if an impact is again received thereafter, there is a possibility that the actuator turns toward the head loading position from the inertia latch position, the inertia latch cannot be carried out in time, and the magnetic head loads on the magnetic disk.

If the comparative examples 1 and 2 are combined, the above drawbacks can be overcome, but this results in the cost being increased.

An embodiment of the present invention will be explained next.

### EMBODIMENT

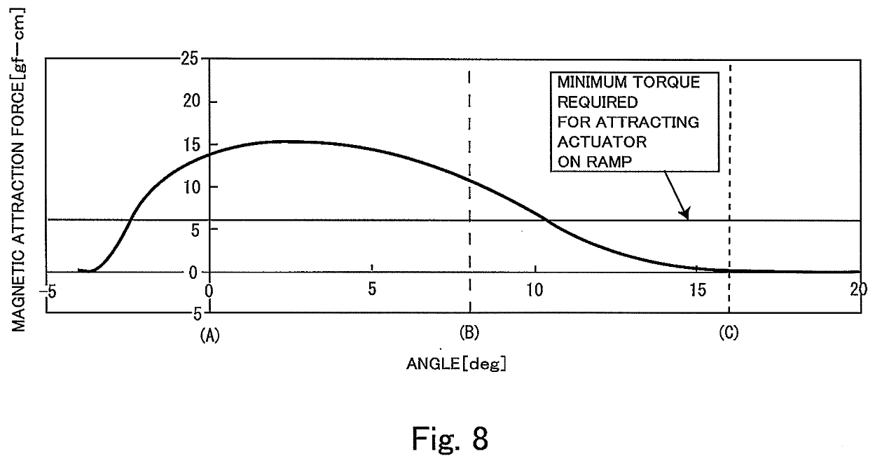

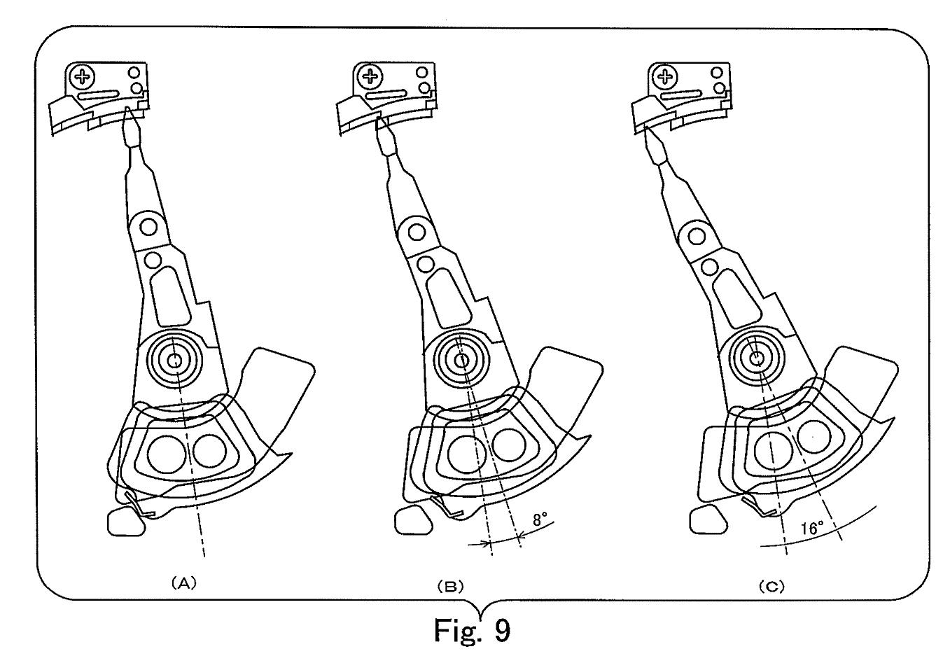

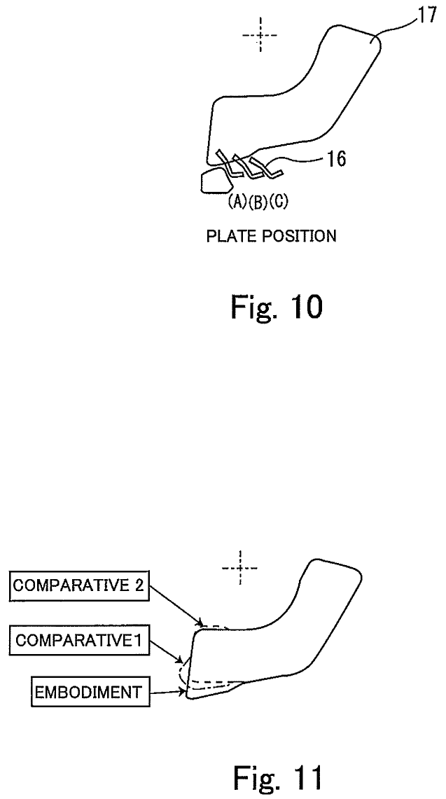

FIG. 8 is a diagram showing a magnetic attraction force received by the plate from a stationary magnet in a magnetic disk apparatus (embodiment, hereinafter) shown in FIG. 1. FIG. 9 is a diagram showing a positional relationship of an actuator with respect to a ramp and an outer stopper in the embodiment. FIG. 10 is a diagram showing shapes of the stationary magnet and the plate, and a position of the plate in each turning position of the actuator in the conventional example. FIG. 11 is a diagram in which a shape of the stationary magnet of the embodiment is superposed on the stationary magnet of the comparative example 1 and on the stationary magnet of the comparative example 2. Similarly to the above examples, marks (+) shown in FIGS. 10 and 11 represent a turning center of the actuator.

Here, (A), (B) and (C) in FIGS. 8 to 10 respectively correspond to one another. Similarly to the comparative examples 1 and 2, (A) shows an outer stopper position where the actuator abuts against the outer stopper, (B) shows an inertia latch catch position where the inertia latch engages the actuator, and (C) shows a head loading position where the magnetic head starts loading on the magnetic disk.

In the case of this embodiment, as shown in FIG. 10, a superposed portion between the plate and the stationary magnet 17 is increased as approaching the outer stopper position (A). This point is the same as that of the comparative example 1 (see FIG. 4). In this embodiment, however, a magnetic attraction force shown in FIG. 8 is produced by device of a shape of the stationary magnet shown in FIG. 11 and device of a shape of the plate 16 as being found by comparison between FIGS. 4 and 10.

In this embodiment, a sufficient magnetic attraction force is obtained when the actuator is located at the outer stopper position (A), and this magnetic attraction force continues to a position where the actuator further turns 2° or more in the unloading direction when the outer stopper did not exist. The angle range where the magnetic attraction force is applied is widened to a position closer to the head loading position than the inertia latch catch position. Thus, for example, after the actuator moves to the inertia latch catch position due to an impact or the like and the inertia latch acts, the actuator can return to the outer stopper position (A) only by its own force, i.e., a magnetic attraction force applied to the plate. Therefore, even if the actuator again receives another impact, the actuator starts from the outer stopper position (A), and when the actuator moves to the inertia latch catch position, the actuator is latched again by the inertia latch, and is prevented from turning to the head loading position.

In addition, in this embodiment, a magnetic attraction force is not applied to the plate 16 in the head loading position (C), and a possibility that control of seek and on-track in the head loading position is adversely affected is eliminated.

Although the magnetic disk apparatus has been explained above, the present invention can also be applied to an apparatus which uses a medium other than a medium which magnetically stores, when the apparatus is a disk apparatus which uses an actuator that is turned by interaction between the stationary magnet and current of the coil, the present invention can also be applied.

What is claimed is:

1. A disk apparatus comprising:
a disk on which information is stored;
a stationary magnet;
an actuator which is turnably supported, which is provided at its tip end with a head that accesses the disk, which is provided at its rear end with a coil that generates a driving force by interaction between the stationary magnet and the actuator, and which is turned by the driving force,
a ramp which holds a tip end of the actuator at an unloading position that is away from the disk; and
an outer stopper which abuts against the rear end of the actuator and which determines the maximum turning position of the actuator in an unloading direction, wherein
the actuator includes a magnetic plate member fixed to the rear end of the actuator and to a tip end of the actuator in the unloading direction, the plate member generates a magnetic attraction force which turns the actuator in the unloading direction by interaction between the stationary magnet and the plate member, the plate member is superposed with the stationary magnet in a plane direction while keeping a gap with the stationary magnet in an up-and-down direction, and an area of the plate member superposed on the stationary magnet is increased as the actuator turns in the unloading direction and approaches the outer stopper, and
when the actuator is in a position close to the outer stopper, the stationary magnet gives, to the plate member, a magnetic attraction force having such an intensity as to cause the actuator to abut on the outer stopper against a friction force applied to the actuator.

2. The disk apparatus according to claim 1, wherein the stationary magnet gives a magnetic attraction force in the unloading direction to the plate member to a position where the actuator further turns 2° or more in the unloading direction than an outer stopper position where the actuator abuts against the outer stopper when the outer stopper does not exist.

3. The disk apparatus according to claim 1, further comprising an inertia latch which receives a driving force by an impact simultaneously when the actuator located in the unloading position receives a driving force in the loading direction by the impact and engages the actuator while the tip end of the actuator is on the ramp, thereby preventing the tip end of the actuator from disengaging from the ramp, wherein
the stationary magnet gives a magnetic attraction force in the unloading direction to the plate member to a position turned in a direction farther away from the outer stopper than a position where the actuator is engaged with the inertia latch.

4. The disk apparatus according to claim 2, further comprising an inertia latch which receives a driving force by an impact simultaneously when the actuator located in the unloading position receives a driving force in the loading direction by the impact and engages the actuator while the tip end of the actuator is on the ramp, thereby preventing the tip end of the actuator from disengaging from the ramp, wherein
the stationary magnet gives a magnetic attraction force in the unloading direction to the plate member to a position turned in a direction farther away from the outer stopper than a position where the actuator is engaged with the inertia latch.

5. The disk apparatus according to claim 1, wherein when the actuator is in a position where the actuator is engaged with the inertia latch, the stationary magnet gives, to the plate member, a magnetic attraction force having an intensity that pulls the actuator back to an outer stopper position where the actuator abuts against the outer stopper from the former position.

6. The disk apparatus according to claim 2, wherein when the actuator is in a position where the actuator is engaged with the inertia latch, the stationary magnet gives, to the plate member, a magnetic attraction force having an intensity that pulls the actuator back to an outer stopper position where the actuator abuts against the outer stopper from the former position.

7. The disk apparatus according to claim 3, wherein when the actuator is in a position where the actuator is engaged with the inertia latch, the stationary magnet gives, to the plate member, a magnetic attraction force having an intensity that pulls the actuator back to an outer stopper position where the actuator abuts against the outer stopper from the former position.

8. The disk apparatus according to claim 1, wherein when the actuator is away from the outer stopper and the head mounted on the tip end of the actuator moves toward the loading position where the head is superposed on the disk, the plate member moves to a position which is out of a region where an influence of a magnetic attraction force from the stationary magnet acts before the actuator reaches the loading position.

9. The disk apparatus according to claim 2, wherein when the actuator is away from the outer stopper and the head mounted on the tip end of the actuator moves toward the loading position where the head is superposed on the disk, the plate member moves to a position which is out of a region where an influence of a magnetic attraction force from the stationary magnet acts before the actuator reaches the loading position.

10. The disk apparatus according to claim 3, wherein when the actuator is away from the outer stopper and the head mounted on the tip end of the actuator moves toward the loading position where the head is superposed on the disk, the plate member moves to a position which is out of a region where an influence of a magnetic attraction force from the stationary magnet acts before the actuator reaches the loading position.

11. The disk apparatus according to claim 4, wherein when the actuator is away from the outer stopper and the head mounted on the tip end of the actuator moves toward the loading position where the head is superposed on the disk, the plate member moves to a position which is out of a region where an influence of a magnetic attraction force from the stationary magnet acts before the actuator reaches the loading position.
